(19) United States
(12) Patent Application Publication
(10) Pub. No.: US 2002/0154843 A1
(43) Pub. Date: Oct. 24, 2002

(54) Dielectric backfill for optical modulators using ridged substrates

(76) Inventor: Gary E. Betts, Westford, MA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/086,171

(22) Filed: Feb. 28, 2002

Related U.S. Application Data
(60) Provisional application No. 60/285,434, filed on Apr. 19, 2001.

(51) Int. Cl. G02F 1/035

(52) U.S. Cl. 385/2; 359/245

(57) ABSTRACT

An optical modulator configured in accordance with the present invention utilizes a ridged optical waveguide substrate. The interferometric arms of the optical waveguide are formed within the substrate ridges. A dielectric material having a dielectric constant less than the dielectric constant of the substrate material is formed on the substrate in the areas surrounding the ridges. The drive signal and ground electrodes are formed above the dielectric layer and positioned such that portions of the electrodes are located adjacent to the substrate ridges (and, consequently, proximate to the waveguide arms). In one embodiment, the height of the dielectric layer is less than the height of the ridges. In another embodiment, the height of the dielectric layer is equal to the height of the ridges.

### CROSS REFERENCE TO RELATED APPLICATIONS

This application claims priority of U.S. provisional application serial No. 60/285,434, the contents of which are incorporated by reference herein.

### STATEMENT REGARDING FEDERALLY SPONSORED RESEARCH OR DEVELOPMENT

The subject matter disclosed herein was made in part with United States government support under contract/grant number “AF CRDA 00-182-1ES” awarded by the United States Air Force. The United States government has certain rights to the invention claimed herein.

### FIELD OF THE INVENTION

The present invention relates generally to optical modulators. More particularly, the present invention relates to optical modulators that utilize ridged waveguide substrates.

### BACKGROUND OF THE INVENTION

Electro-optic modulators (also referred to as optical modulators) convert an electrical input signal into a modulated optical signal. At the present time, optical modulators are a key component in commercial long distance, high speed digital data communication systems. The well known Mach-Zehnder interferometric modulator provides the purest optical spectrum and, therefore, is the primary modulator type employed in practical long distance fiber optic systems. A Mach-Zehnder optical modulator having a conventional electrode structure includes a central drive electrode and two outer ground electrodes formed above a substrate. Briefly, a typical Mach-Zehnder optical modulator receives a data signal from a driver amplifier component, along with an unmodulated continuous wave (CW) optical input. The optical modulator modulates the optical signal in response to the electrical data signal. The optical input is carried by an optical waveguide formed within the substrate, and the electrical data signal propagates over a transmission line defined by the electrode structure.

Modulator substrates such as lithium niobate have a relatively high dielectric constant at microwave frequencies and a relatively low dielectric constant at optical frequencies, which creates a velocity matching problem (ideally, the velocity of the electrical signal propagating through the transmission line equals the velocity of the optical signal traveling through the waveguide). One solution to this problem utilizes modulators that are specifically designed such that much of the electric field of the microwave signal travels in regions of material having a relatively low dielectric constant. For example, one prior art modulator design utilizes a substrate having ridges in which the optical waveguide is formed. FIG. 6 is a cross-sectional view of an optical modulator that employs a ridged substrate. As shown, the electrodes are deposited on the substrate material surrounding the ridges, and portions of the electrodes are deposited on the upper surface of the ridges. This prior art design allows a portion of the electrical energy to pass through air (rather than through the lithium niobate) while maintaining the field strength in the lithium niobate necessary to perform modulation.

### BRIEF SUMMARY OF THE INVENTION

An optical modulator according to the present invention employs a ridged substrate and dielectric backfill that substantially isolates the electrodes from the substrate material. The dielectric material has a low dielectric constant relative to the dielectric constant of the substrate material. This configuration allows the use of electrodes with relatively large dimensions (to achieve low electrical loss), with only a small portion of the electrodes near the substrate material.

The above and other aspects of the present invention may be carried out in one form by an optical modulator comprising a substrate having an upper surface, a first ridge protruding above the upper surface, and a second ridge protruding above the upper surface, an optical waveguide formed within the substrate, where the optical waveguide has a first arm, at least a portion of which is formed within the first ridge, and a second arm, at least a portion of which is formed within the second ridge, a dielectric section formed on the upper surface of the substrate between the first and second ridges, and an electrode formed above the dielectric layer.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic top view of an example optical modulator configured in accordance with the present invention;

FIG. 2 is a cross-sectional view of the optical modulator, as viewed along line A-A in FIG. 1;

FIG. 3 is a schematic top view of another example optical modulator configured in accordance with the present invention;

FIG. 4 is a cross-sectional view of the optical modulator, as viewed along line B-B in FIG. 3;

FIG. 5 is a cross-sectional view of an alternately configured optical modulator; and

FIG. 6 is a cross-sectional view of a prior art optical modulator with a ridged substrate.

### DETAILED DESCRIPTION OF A PREFERRED EMBODIMENT

The particular implementations shown and described herein are illustrative of the invention and its best mode and are not intended to otherwise limit the scope of the invention in any way. Indeed, for the sake of brevity, the operation of conventional optical modulators, conventional RF design techniques, and functional aspects of known components and subsystems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

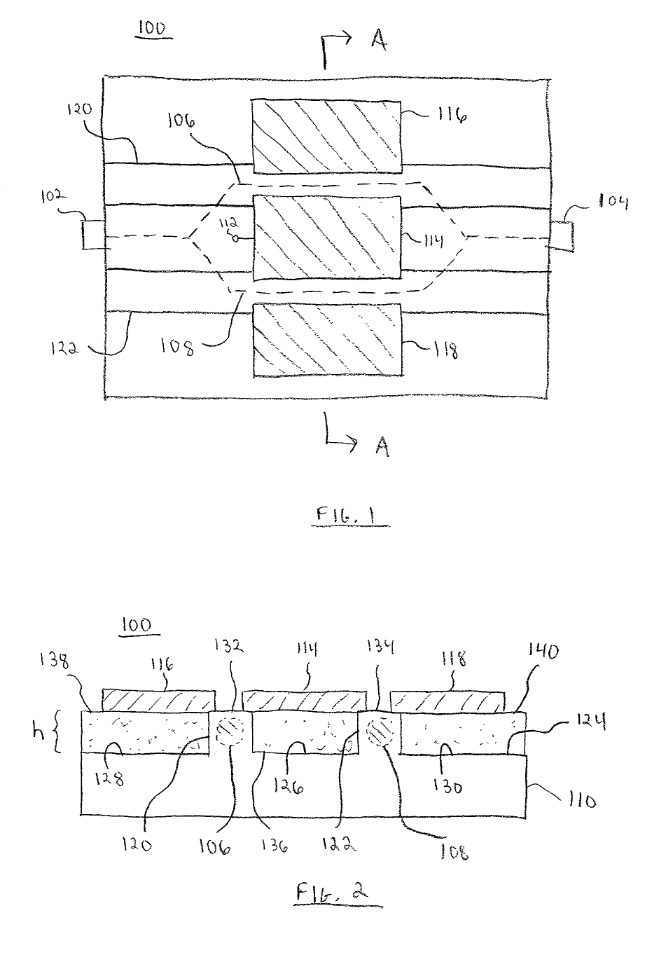

An optical modulator 100 configured in accordance with the present invention is shown in FIG. 1 and FIG. 2. As an example of a practical embodiment, optical modulator 100 is configured as a Mach-Zehnder optical modulator. Optical modulator 100 receives a continuous wave (CW) optical input signal carried by an input optical fiber 102 and generates a modulated optical output signal carried by an output optical fiber 104. The optical signal travels in a branched optical waveguide arrangement having a first interferometric arm 106 and a second interferometric arm 108. The optical waveguide is formed within a substrate 110 of optical modulator 100. In FIG. 1, the optical waveguide, which would otherwise be hidden from view, is represented by dashed lines.

A high frequency electrical data signal (e.g., an RF signal) is utilized to drive optical modulator 100. Optical modulator 100 receives the electrical drive signal via a suitable data input connection 112. The drive signal is carried by a drive signal electrode 114. In a practical embodiment, the RF drive signal may also include a DC component that provides the DC bias voltage for optical modulator 100. Drive signal electrode 114, a first ground electrode 116, and a second ground electrode 118 combine to form a microwave transmission line, which is terminated by suitable resistances (not shown). This electrode structure is commonly referred to as a coplanar waveguide (CPW) transmission line. The electrical data signal modulates the optical signal in first interferometric arm 106 (due to the positioning of drive signal electrode 114 and first ground electrode 116 relative to first interferometric arm 106), and modulates the optical signal in second interferometric arm 108 (due to the positioning of drive signal electrode 114 and second ground electrode 118 relative to second interferometric arm 108). The electrical data signal, which should travel along the electrodes at approximately the same speed as the light traveling in the optical waveguide, alters the refractive index of the optical waveguide. Due to the phase difference between the optical signal in the two interferometric arms, amplitude modulation occurs in the optical output signal.

In the preferred practical embodiment, substrate 110 is formed from lithium niobate crystal, which exhibits a relatively high dielectric constant at microwave frequencies (εᵣ=35) and a relatively low dielectric constant at optical frequencies (εᵣ=4.6). Other suitable substrate materials, such as lithium tantalate or semiconductors, may be utilized in a practical embodiment.

Substrate 110 includes a first ridge 120 and a second ridge 122. Ridges 120/122 protrude above an upper surface 124 of substrate 110 and effectively divide upper surface 124 into a first area 126 between ridges 120/122, a second area 128 adjacent to first ridge 120, and a third area 130 adjacent to second ridge 122. In the illustrated example, upper surface 124 is coplanar (within practical tolerances) in all areas surrounding ridges 120/122. Alternatively, substrate 110 may include an offset upper surface having sections of varied thickness (not shown). In the preferred practical embodiment, ridges 120/122 each extend to a height (h) above upper surface 124. Typical values for h range between 2 μm to 8 μm. Alternatively, first ridge 120 and second ridge 122 may extend to different heights above upper surface 124. First ridge 120 terminates at an upper surface 132, and second ridge terminates at an upper surface 134 (in the example embodiment, upper surfaces 132/134 are coplanar to within practical tolerances).

In a practical embodiment, ridges 120/122 are each approximately 10 μm wide in a substrate such as lithium niobate where the optical mode width is about 8 μm. Narrower ridges result in more efficient modulation, but bringing the ridge wall too close to the optical mode increases the optical loss. In the example embodiment shown in FIG. 1 and FIG. 2, the respective sidewalls of ridges 120/122 are parallel to each other and perpendicular to upper surface 124 of substrate 110. Alternatively, the sidewalls of ridges 120/122 may be angled (inwardly or outwardly), concave, convex, stepped, or shaped in any desired configuration. As shown in FIG. 1, the example embodiment utilizes straight and parallel ridges 120/122 and a straight CPW electrode structure. In practice, ridges 120/122 and/or the electrode structure may be curved, bent, or angled (as viewed from the perspective of FIG. 1) to suit the particular application.

The optical waveguide is formed within substrate 110 using known techniques. At least a portion of the optical waveguide is formed within first ridge 120, and at least a portion of the optical waveguide is formed within second ridge 122. In the example embodiment, a section of first interferometric arm 106 is formed within first ridge 120, and a section of second interferometric arm 108 is formed within second ridge 122. The location of ridges 120/122 relative to electrodes 114/116/118, and the formation of interferometric arms 106/108 within ridges 120/122 facilitates velocity matching by reducing the amount of electrical energy that passes from the electrodes through substrate 110.

Optical modulator 100 includes a dielectric layer comprising a first dielectric section 136, a second dielectric section 138, and a third dielectric section 140. First dielectric section 136 is formed on first area 126 of upper surface 124, second dielectric section 138 is formed on second area 128 of upper surface 124, and third dielectric section 140 is formed on third area 130 of upper surface 124. As shown in FIG. 2, first dielectric section 136 is located between ridges 120/122, second dielectric section 138 is located on the outside of ridge 120, and third dielectric section 140 is located on the outside of ridge 122. In a practical embodiment, first dielectric section 136 abuts the inner sidewalls of both ridges 120/122, second dielectric section 138 abuts the outer sidewall of ridge 120, and third dielectric section abuts the outer sidewall of ridge 122.

The dielectric layer in optical modulator 100 has a height equal (within practical tolerances) to the height of ridges 120/122. In the example embodiment where upper surface 124 is substantially coplanar and ridges 120/122 are of equal height, the height/thickness of the dielectric layer above upper surface 124 is uniform and equal to the height of ridges 120/122. In practice, a suitable dielectric material is deposited over substrate 110 to a thickness that exceeds the height of ridges 120/122. Thereafter, the surface of the assembly can be polished or planarized such that the upper surfaces of ridges 120/122 are coplanar with the upper surfaces of dielectric sections 136/138/140. The resulting flat surface can thereafter be utilized for the deposition and patterning of the electrodes. In this example embodiment, the dielectric thickness is the same as the ridge height.

Although not a requirement of the present invention, in preferred practical embodiments, dielectric sections 136/138/140 are formed from the same dielectric material. The dielectric layer is formed from a material having a dielectric constant that is less than the dielectric constant of the material utilized for substrate 110. In accordance with one practical embodiment, the dielectric layer is formed from the photosensitive material known as SU-8 (εᵣ=4). Alternatively, the dielectric layer may be formed from polyimide (εᵣ=3.5) or any suitable material having a lower dielectric constant than substrate 110.

Drive signal electrode 114 is formed above first dielectric section 136, first ground electrode 116 is formed above second dielectric section 138, and second ground electrode 118 is formed above third dielectric section 140. To facilitate effective modulation of the optical signal traveling through the optical waveguide, drive signal electrode 114 is located adjacent to ridges 120/122, first ground electrode 116 is located adjacent to ridge 120, and second ground electrode 118 is located adjacent to ridge 122. In the example embodiment, the electrodes contact at least a portion of the respective dielectric sections. As shown in FIG. 2, a first portion of drive signal electrode 114 contacts upper surface 132 of first ridge 120, and a second portion of drive signal electrode 114 contacts upper surface 134 of second ridge 122. Likewise, a portion of first ground electrode 116 may contact upper surface 132 of first ridge 120, and a portion of second ground electrode 118 may contact upper surface 134 of second ridge 122. Thus, as depicted in FIG. 1, drive electrode 114 overlaps a portion of both ridges 120/122, first ground electrode 116 overlaps a portion of ridge 120, and second ground electrode 118 overlaps a portion of ridge 122. The electrodes may be thin (e.g., a few tenths of a micron) or they may be plated to achieve a relatively large thickness (e.g., up to 30 μm).

The proximity of the electrodes to the ridges 120/122 allows the use of relatively large electrodes that exhibit low electrical losses, while only a small portion of the electrodes remain near substrate 110 (which has a relatively high dielectric constant). In practice, most of the transferred electrical energy passes through the dielectric layer rather than through the substrate material. In this regard, sufficient field strength in the optical waveguide can be achieved wile maintaining an electrical velocity that approximates the velocity of the optical signal in the waveguide.

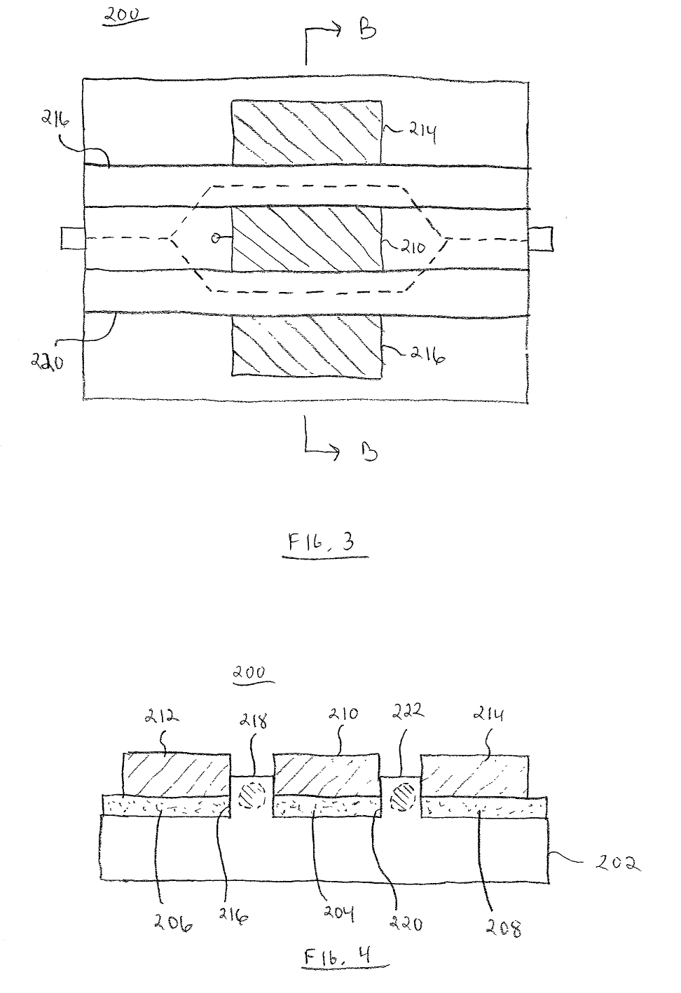

An alternate optical modulator 200 configured in accordance with the present invention is shown in FIG. 3 and FIG. 4. Optical modulator 200 shares a number of features with optical modulator 100. Accordingly, the following description of optical modulator 200 focuses on those aspects that differ from optical modulator 100. Consequently, portions of the above description of optical modulator 11 00 may also apply in the context of optical modulator 200. In general, the materials used to form the substrate, dielectric layer, and electrodes of optical modulator 200 may be identical to the respective materials used in optical modulator 100.

Optical modulator 200 generally includes a substrate 202, an optical waveguide formed within substrate 202, a dielectric layer comprising a first section 204, a second section 206, and a third section 208, a drive signal electrode 210, a first ground electrode 212, and a second ground electrode 214. Substrate 202 includes a first ridge 216 having an upper surface 218, and a second ridge 220 having an upper surface 222.

As best shown in FIG. 4, each of the dielectric sections 204/206/208 has a height less than the height of ridges 216/220. In the example embodiment, the upper surfaces of dielectric sections 204/206/208 are coplanar (within practical tolerances). Fabrication of optical modulator 200 can be challenging because the dielectric layer terminates below the upper surfaces 218/222 of ridges 216/220.

Drive signal electrode 210 includes a lower surface located below upper surfaces 218/222 of ridges 216/220, first ground electrode 212 has a lower surface located below upper surface 218 of ridge 216, and second ground electrode has a lower surface located below upper surface 222 of ridge 220. In the example embodiment, the lower surfaces of the electrodes contact the respective dielectric sections. Although not depicted as such in FIG. 4, the height of the electrodes need not exceed the height of ridge 216 and/or ridge 220.

In the practical embodiment, a first portion of drive signal electrode 210 contacts the inner sidewall of ridge 216, and a second portion of drive signal electrode 210 contacts the inner sidewall of ridge 218. Likewise, a portion of first ground electrode 212 contacts the outer sidewall of ridge 216, and a portion of second ground electrode 214 contacts the outer sidewall of ridge 220. In the illustrated embodiment, the side edges of the electrodes contact the respective sidewalls of the ridges. Notably, upper surfaces 218/222 of ridges 216/220 remain free of dielectric material, and the electrodes are positioned adjacent to the respective ridges 216/220. In the example embodiment, drive signal electrode 210 fits between ridges 216/220. This electrode configuration provides a very strong electric field in the waveguide region and facilitates effective velocity matching.

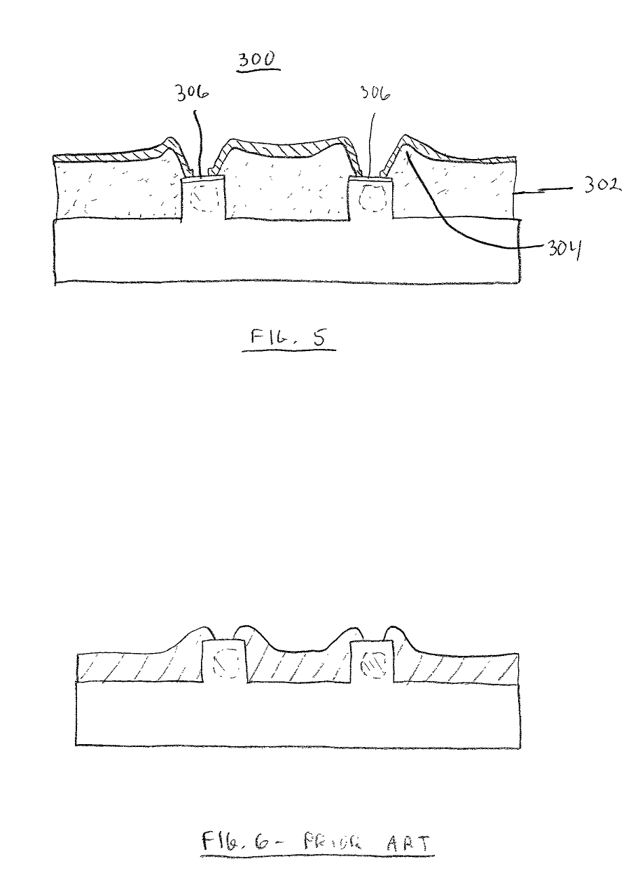

An alternative means of fabricating a similar structure is to deposit a planarizing dielectric material such as polyimide (εᵣ=3.5) over the substrate, open a gap over the substrate ridges using photolithographic techniques, and pattern the metalization with a smaller gap so that portions of the electrodes contact the upper surface of the ridges. FIG. 5 is a cross-sectional view of an optical modulator 300 having such a configuration. In this case, the final thickness of the dielectric backfill layer 302 at a point 304 away from the ridge edge may be greater than (or less than) the height of the ridge.

The illustrations and examples described herein focus on the use of a dielectric backfill between the electrodes and the modulator substrate. This concept may be used in conjunction with any of the many varieties of electrode design commonly used in modulators, such as thin insulating buffer layers, conductive buffer layers, multiple metal layers, oddly shaped electrodes, and the like. For example, the example embodiment of FIG. 5 includes a thin insulating buffer material 306 (e.g., silicon dioxide having a thickness of 0.2 μm) on the upper surface of the ridges to reduce optical loss from the electrodes. The techniques of the present invention can be equivalently applied whether this layer is present or whether the electrodes directly contact the ridge surface. One skilled in the art should be able to comprehend the applicability of the present invention to various electrode designs, and no attempt will be made here to exhaustively show all the possible practical combinations.

The present invention has been described above with reference to preferred embodiments. However, those skilled in the art having read this disclosure will recognize that changes and modifications may be made to the preferred embodiments without departing from the scope of the present invention. These and other changes or modifications are intended to be included within the scope of the present invention, as expressed in the following claims.

What is claimed is:

1. An optical modulator comprising:
a substrate having an upper surface and a ridge protruding above said upper surface, said ridge extending to a height above said upper surface;
an optical waveguide formed within said substrate, at least a portion of which is formed within said ridge;
a dielectric layer formed on said upper surface of said substrate, said dielectric layer having a height less than or equal to the height of said ridge; and
an electrode formed above said dielectric layer and located adjacent to said ridge.

2. An optical modulator according to claim 1, wherein:
the height of said dielectric layer is equal to the height of said ridge; and
a portion of said electrode contacts an upper surface of said ridge.

3. An optical modulator according to claim 1, wherein:
the height of said dielectric layer is less than the height of said ridge; and
said electrode includes a lower surface located below an upper surface of said ridge.

4. An optical modulator according to claim 3, wherein:
said ridge includes a sidewall; and
a portion of said electrode contacts said sidewall of said ridge.

5. An optical modulator according to claim 1, wherein:
said substrate is formed from a material having a first dielectric constant; and
said dielectric layer is formed from a material having a second dielectric constant that is less than said first dielectric constant.

6. An optical modulator according to claim 5, wherein said substrate is formed from lithium niobate crystal.

7. An optical modulator according to claim 6, wherein said dielectric layer is formed from SU-8.

8. An optical modulator comprising:
a substrate having an upper surface, a first ridge protruding above said upper surface, and a second ridge protruding above said upper surface;
an optical waveguide formed within said substrate, said optical waveguide having a first arm, at least a portion of which is formed within said first ridge, and a second arm, at least a portion of which is formed within said second ridge;
a dielectric section formed on said upper surface of said substrate between said first ridge and said second ridge; and
an electrode formed above said dielectric layer.

9. An optical modulator according to claim 8, wherein:
said substrate is formed from a material having a first dielectric constant; and
said dielectric section is formed from a material having a second dielectric constant that is less than said first dielectric constant.

10. An optical modulator according to claim 8, wherein said electrode is located adjacent to said first ridge.

11. An optical modulator according to claim 10, wherein said electrode is located adjacent to said second ridge.

12. An optical modulator according to claim 8, wherein:
said first ridge extends to a first height above said upper surface of said substrate;
said second ridge extends to a second height above said upper surface of said substrate; and
said dielectric layer extends to a third height above said upper surface of said substrate, said third height being less than or equal to said first height and less than or equal to said second height.

13. An optical modulator according to claim 12, wherein said first height and said second height are equal.

14. An optical modulator according to claim 8, wherein said first ridge and said second ridge are parallel.

15. An optical modulator comprising:
a substrate having an upper surface and a ridge protruding above said upper surface, said ridge dividing said upper surface into a first area and a second area;
an optical waveguide formed within said substrate, at least a portion of which is formed within said ridge;
a first dielectric section formed on said first area of said upper surface, said first dielectric section having a height less than or equal to the height of said ridge;
a second dielectric section formed on said second area of said upper surface, said second dielectric section having a height less than or equal to the height of said ridge;
a first electrode formed above said first dielectric layer; and
a second electrode formed above said second dielectric layer.

16. An optical modulator according to claim 15, wherein said first electrode and said second electrode are each located adjacent to said ridge.

17. An optical modulator according to claim 15, wherein said first electrode is a drive signal electrode and said second electrode is a ground electrode.

18. An optical modulator according to claim 15, wherein:
said substrate is formed from a material having a substrate dielectric constant;
said first dielectric section is formed from a material having a dielectric constant that is less than said substrate dielectric constant; and
said second dielectric section is formed from a material having a dielectric constant that is less than said substrate dielectric constant.

19. An optical modulator comprising:
a substrate having an upper surface, a first ridge protruding above said upper surface, and a second ridge protruding above said upper surface, said first and second ridges dividing said upper surface into a first area between said first and second ridges, a second area adjacent to said first ridge, and a third area adjacent to said second ridge;
an optical waveguide formed within said substrate, said optical waveguide having a first arm, at least a portion of which is formed within said first ridge, and a second arm, at least a portion of which is formed within said second ridge;
a first dielectric section formed on said first area of said upper surface;
a second dielectric section formed on said second area of said upper surface;
a third dielectric section formed on said third area of said upper surface;
a first electrode form ed above said first dielectric section;
a second electrode formed above said second dielectric section; and
a third electrode formed above said third dielectric section.

20. An optical modulator according to claim 19, wherein:
each of said first and second ridges extends to a height above said upper surface of said substrate; and
each of said first, second, and third dielectric sections has a height less than the height of said first and second ridges.

21. An optical modulator according to claim 19, wherein:
each of said first and second ridges extends to a height above said upper surface of said substrate; and
each of said first, second, and third dielectric sections has a height equal to height of said first and second ridges.

22. An optical modulator according to claim 19, wherein:
said substrate is formed from a material having a substrate dielectric constant; and
each of said first, second, and third dielectric sections is formed from a material having a dielectric constant less than said substrate dielectric constant.

23. An optical modulator according to claim 19, wherein said first electrode is a drive signal electrode and each of said second and third electrodes is a ground electrode.

24. An optical modulator according to claim 23, wherein said first, second, and third electrodes are configured as a coplanar waveguide transmission line.
